(19) United States
(12) Patent Application Publication
(10) Pub. No.: US 2017/0339909 A1
(43) Pub. Date: Nov. 30, 2017

(54) FOLDABLE FABRIC CASE FOR TRANSPORTING ANIMAL CAGES

(71) Applicant: Danielle K. Mimms, Dallas, PA (US)

(72) Inventor: Danielle K. Mimms, Dallas, PA (US)

(21) Appl. No.: 15/604,211

(22) Filed: May 24, 2017

Related U.S. Application Data
(60) Provisional application No. 62/341,070, filed on May 24, 2016.

(51) Int. Cl. A01K 1/00; A45C 11/24

(52) U.S. Cl. CPC A01K 1/0035; A45C 11/24

(57) ABSTRACT

A foldable fabric case that encases a collapsible animal carrier when the carrier is collapsed for transport includes a removable handle and a removable, adjustable safety leash that wraps substantially horizontally around the carrier to secure and protect the collapsible animal carrier when traveling.

This application claims priority from U.S. Provisional Application Ser. No. 62/341,070 filed May 24, 2016, the content of which is hereby incorporated by reference in its entirety.

### BACKGROUND OF THE INVENTION

### 1. Field of the Invention

The present invention relates to carrier cases and, more particularly, to a foldable fabric case that encases a collapsible animal carrier when the carrier is collapsed for transport.

### 2. Description of the Related Art

It is desirable to ease the transport of a collapsible dog crate, and to provide a padded insert for the collapsible dog crate after the collapsed crate is constructed for the use by the dog.

U.S. Pat. No. 6,948,599 to Rodrigue et al. discloses an insert for use with a conventional sports bag for organizing, carrying, drying, and storing sports gear. The insert has mesh pockets, straps for attaching clothing and equipment to the insert, and loops for suspending the insert from a hook. This patent explains the insert can easily be pulled into a shape that fits into a conventional sports bag. Once inserted into the sports bag, all the pockets on the insert remain fully functional and accessible, with the openings of the large mesh pockets and the full-size mesh pocket being readily accessible from the top of the sports bag.

U.S. Pat. No. 6,155,206 to Godshaw discloses a small animal carrier comprising fabric formed in a rectangular parallelpiped shape with a collapsible wire metal cage that is positionable on support pads within the carrier. Recessed wheels are positioned on the bottom side of the carrier and are attached to a stiffening board that enhances the structural integrity of the carrier.

U.S. Pat. No. 5,603,573 to Mercier et al. disclose a multi-use bag, particularly for the transport of a small animal. The bag in accordance with this invention comprises a support including three interconnected panels that form an assembly having a U-shaped profile, which open at two opposite ends, and a container adapted to fit in the support, where a tray is provided between the support and the container.

U.S. Pat. No. 4,112,991 to Barbaresi discloses a handbag having a relatively rigid basket-like frame and a soft fabric bag carried therein. The bag includes pocketed flaps that engage wings formed on the basket. Additional securement is obtained via handle chains that loop through openings in the basket and bag.

### SUMMARY OF THE INVENTION

Disclosed is a foldable fabric case or carrier having a rectangular, padded shape that encases a collapsible animal carrier when the carrier is collapsed for transport. The carrier has a removable handle that is used for carrying the encased animal carrier and a removable safety leash that wraps substantially horizontally around the carrier to secure the collapsible animal carrier when travelling.

The foldable fabric case or carrier is configured to assist in the ease of transporting the collapsible animal carrier, and is configured to provide a padded insert for the collapsible animal carrier once the collapsible animal carrier is constructed for use. The foldable fabric case or carrier provides a protective outer shell for the animal carrier, and also protects other surfaces from being scratched and/or scraped by the hard edges of the collapsed animal carrier during transport.

In accordance with the invention, the foldable fabric case comprises three main parts, e.g., a carrier, a removable handle, and an adjustable, removable safety leash. The carrier is formed from two pieces of fabric, a single piece of an upholstery grade fiber comprising Dacron™ and a single piece of synthetic fiber (i.e., the removable handle) that is cut to a predetermined length, as well as a number of D-rings. The D-rings are held in loops segments, which are formed from the same synthetic fiber as the removable handle, and which are attached to external outer edges of the carrier. The loop segments are inserted between one of the fabrics and the Dacron™, and sewn in place to form a layer sequence comprising fabric, loop segments, Dacron™ and fabric.

The removable handle includes two bolt snaps connected via a single section of synthetic fiber or polypro webbing. In the preferred embodiment, the section of synthetic fiber or polypro webbing of the removable handle is ten inches long.

The adjustable, removable safety leash comprises a single bolt snap, a single D-ring, a single tri-glide, and a single continuous piece of synthetic fiber or polypro webbing.

In accordance with the disclosed embodiments, the folding fabric is provided in two sizes to accommodate different size collapsible animal carriers (crates).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is an illustration of the foldable fabric case in an unfolded state in accordance with the invention;

FIG. 2 is an illustration of the D-rings held in loops segments which are attached to external outer edges of the carrier of foldable fabric case in accordance with the invention;

FIG. 3 is an illustration of the removable handle in accordance with the invention;

FIG. 4 is an illustration of the foldable fabric case in a folded state in accordance with the invention; and

FIG. 5 is an illustration of the adjustable removable safety leash in accordance with the invention.

### DETAILED DESCRIPTION OF THE EXEMPLARY EMBODIMENTS

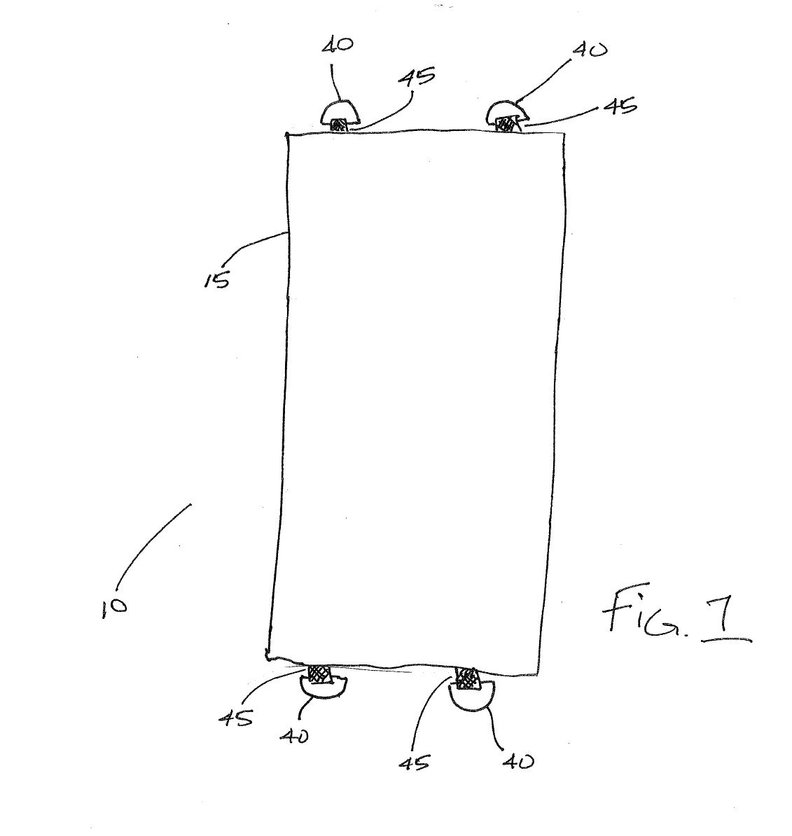

With reference to FIG. 1, the foldable fabric case 10 comprises three main parts, e.g., a carrier 15, a removable handle 20, and an adjustable, removable safety leash 30. The carrier 15 is formed from two pieces of fabric, a single piece of an upholstery grade fiber comprising Dacron™ and a single piece of a synthetic fiber (i.e., the removable handle 20) that is cut to a predetermined length, as well as multiple D-rings 40. In the preferred embodiment, the fabrics are cotton based fabrics, the synthetic fiber or polypro webbing is substantially flat, has a width of approximately one inch and is a synthetic polyester (polyethylene terephthalate) used as a textile fabric having tough, elastic properties, and four D-rings 40 having a one inch diameter are used. In preferred embodiments, the Dacron™ is substantially the same size as the two pieces of fabric that form the carrier.

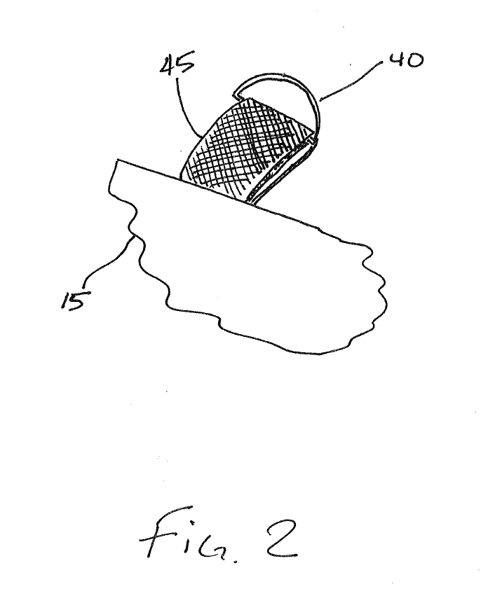

With respect to the D-rings 40, these are held in loops segments 45, which are formed from the same synthetic fiber as the removable handle 20, and which are attached to external outer edges of the carrier 15, as shown in FIG. 2. In the preferred embodiment, a total of four loop segments 45 are attached to the carrier 15 and, in this way, when the carrier 15 is folded in half the removable handle 20 can be attached to the carrier 15 via conventional bolt snaps 25 that are commonly used for dog leashes. Here, the loop segments 45 are arranged opposite to each other in a mirrored manner. In this way, uniformity and symmetry is maintained or achieved when the carrier 15 is folded in half. In other preferred embodiments, the loop segments 45 are inserted between one of the fabrics and the Dacron™, and sewn in place to form a layer sequence comprising fabric, loop segments, Dacron™ and fabric.

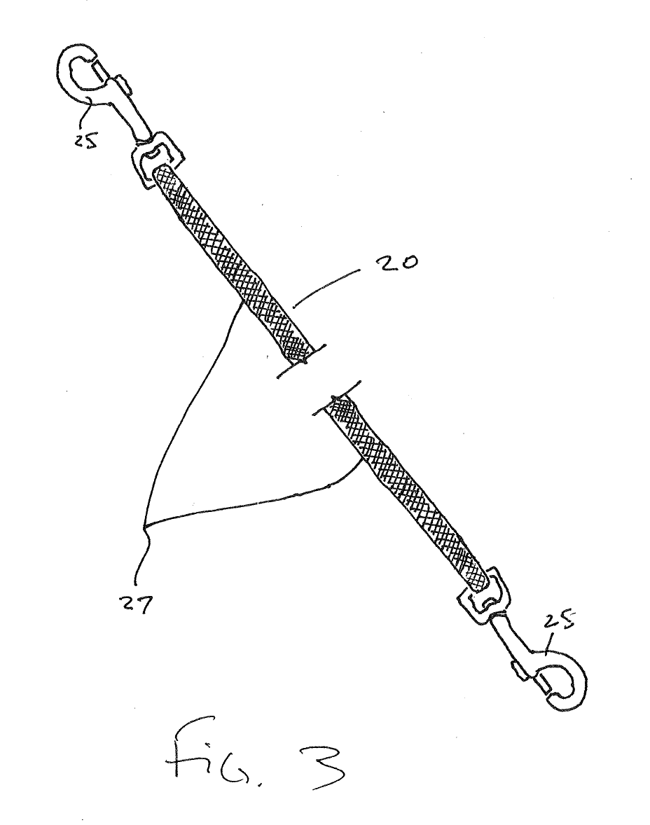

A detail of the removable handle 20 is shown in FIG. 3. Here, the removable handle 20 includes two bolt snaps 25 connected via a single section of synthetic fiber or polypro webbing 27. In the preferred embodiment, the single section of synthetic fiber is approximately ten inches long.

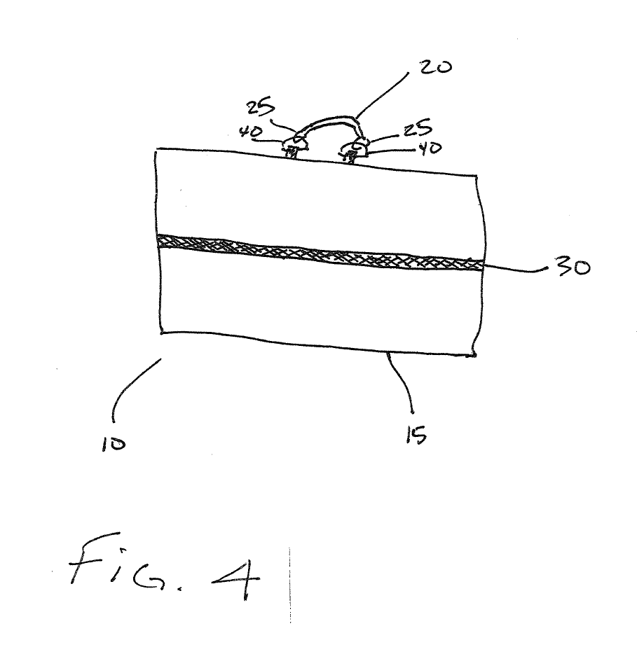

FIG. 4 is a detailed illustration of the adjustable, removable safety leash 30. With specific reference to FIG. 4, the adjustable, removable safety leash 30 comprises a single bolt snap 25, a single D-ring 40, a single tri-glide 50, and a single continuous piece of synthetic fiber or polypro webbing 55. Tri-glides are frequently used as adjusters on back pack straps, or other types of belts. They are used to lengthen or shorten a strap to which it is attached. In the preferred embodiment, the single bolt snap 25 and the single D-ring 25 are approximately one inch in diameter, the adjustable, removable safety leash 30 is approximately one inch wide and is approximately 72 inches long. It should be understood, however, these sizes are exemplary and it is not the intention to be limited to only these exemplary sizes.

In accordance with the disclosed embodiments, the foldable carrier case 10 is provided in two sizes to accommodate different sized collapsible animal carriers (crates). In one embodiment, the smaller sized fabric is 32 inches wide by 46 inches long. In other embodiments, the larger sized fabric is 38 inches wide by 50 inches long.

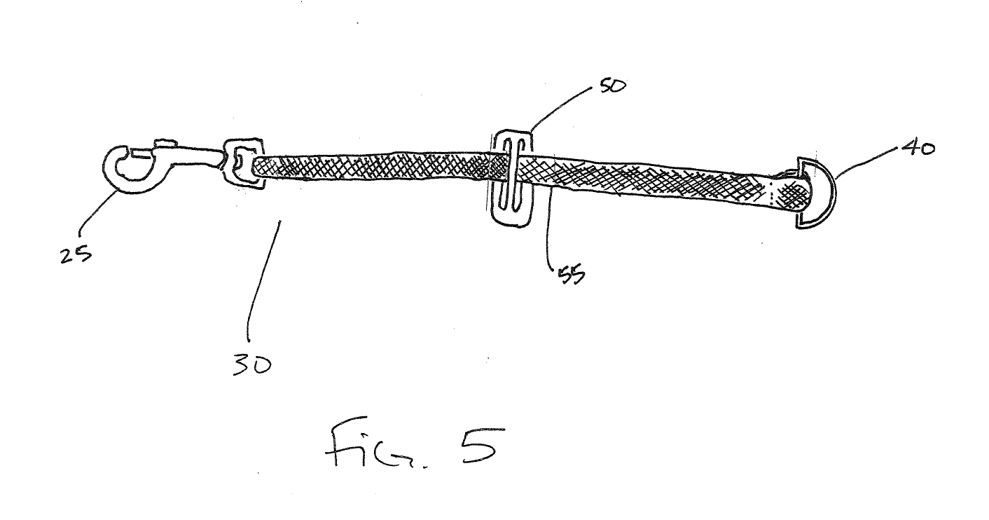

The foldable fabric case 10 is used by laying it on a surface and opening it (see FIG. 1). A collapsed animal carrier (not shown) is now placed on one half of the foldable carrier case 10 and the remaining section of the foldable fabric case 10 is folded over the animal carrier (not shown). The removable handle 20 is now clipped to the foldable fabric case 10 via the holder and the adjustable, removable safety leash 30 is wrapped horizontally around the foldable fabric case 10, as shown in FIG. 5. It should be noted the adjustable, removable safety leash 30 can be adjusted to secure the collapsible animal carrier tightly (see FIG. 2).

After the animal carrier is secured on the inside of the foldable fabric case 10, the entire assemble is now ready for use by grabbing the handle 20 to carry it. When the final destination is reached, the removable handle 20 and the adjustable, removable safe leash 30 are removed, and the animal carrier (not shown) is then removed. When the animal carrier is re-constructed, the foldable fabric case 10 can be folded to a size that permits its insertion into the animal carrier and can be placed at the bottom of the animal carrier as a cushion for an animal, such as a dog.

Additional uses for the foldable fabric case 10 could include but not is limited to a seat cover for a car, a cover for a couch and a pet mat. In other embodiments, the adjustable, removable safety leash 30 is paired with the removable handle 20 to create a dog leash.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto

I claim:

1. A foldable fabric case that encases a collapsible animal carrier when the carrier is collapsed for transport, the foldable fabric case comprising:
a carrier comprising a plurality of cotton based fabrics;
a handle removeably attached to the carrier; and
an adjustable safety leash removeably attached to the carrier at a horizontally central location of the carrier.

2. The foldable fabric case of claim 1, the carrier further comprises:
a single piece of upholstery grade fiber.

3. The foldable fabric case of claim 1, further comprising:
a plurality of D-rings held in loops segments which are attached to external outer edges of the carrier.

4. The foldable fabric case of claim 2, wherein the single piece of upholstery grade fiber comprises Dacron™.

5. The foldable fabric case of claim 3, wherein the single piece of upholstery grade fiber is substantially the same size as the two pieces of fabric that form the carrier.

6. The foldable fabric case of claim 3, wherein four loop segments are attached to the carrier via four loops segments.

7. The foldable fabric case of claim 3, wherein the loop segments are arranged opposite to each other in a mirrored manner.

8. The foldable fabric case of claim 3, wherein the loop segments 45 are inserted between one of the fabrics and the single piece of upholstery grade fiber, and sewn in place to form a layer sequence comprising fabric, loop segments, the single piece of upholstery grade fiber and another fabric.

9. The foldable fabric case of claim 1, wherein removable handle includes two bolt snaps connected via a single section of synthetic fiber or polypro webbing.

10. The foldable fabric case of claim 9, wherein the single section of synthetic fiber or polypro webbing is approximately ten inches long.

11. The foldable fabric case of claim 1, wherein the adjustable, removable safety leash comprises a single bolt snap, a single D-ring, a single tri-glide, and a single continuous piece of synthetic fiber or polypro webbing.

12. The foldable fabric case of claim 11, wherein the single bolt snap and the single D-ring are approximately one inch in diameter, the adjustable, removable safety leash is approximately one inch wide and is approximately seventy two inches long.
